(19) United States
(12) Patent Application Publication
(10) Pub. No.: US 2025/0322257 A1
(43) Pub. Date: Oct. 16, 2025

(54) CLIENT NODE SELECTION AND WEIGHTING OR PRUNING THEIR CONTRIBUTIONS IN A FL ENVIRONMENT

(71) Applicant: Dell Products L.P., Round Rock, TX (US)

(72) Inventors: Eduarda Tatiane Caetano Chagas, Belo Horizonte (BR); Leandro Takeshi Hattori, Campo Grande (BR); Maira Beatriz Hernandez Moran, Rio de Janeiro (BR); Yanexis Pupo Toledo, Niterói (BR)

(21) Appl. No.: 18/635,751

(22) Filed: Apr. 15, 2024

(51) Int. Cl. G06N 3/098

(52) U.S. Cl. CPC G06N 3/098

(57) ABSTRACT

One example method includes a first function for calculating a correlation metric based on a historical consistency of a local ML model that is returned encrypted to a central server from client nodes of a federated learning system. A model is used to monitor network traffic between the central server and the client nodes to detect anomalous network traffic behavior based on historical network traffic behavior. A second function calculates a performance score based on a historical performance of the local ML model. A client node score is calculated based on the correlation metric, any detected anomalous behavior in the network traffic, and the performance score. One or more client nodes are selected based on the client node score. A global model is updated by aggregating the local models returned to the central server from the selected client nodes, weighting their contributions according to their score.

### TECHNOLOGICAL FIELD OF THE DISCLOSURE

Embodiments of the present invention generally relate to federated learning processes. More particularly, at least some embodiments of the invention relate to systems, hardware, software, computer-readable media, and methods for weighting or pruning client node contributions in a federated learning system.

### BACKGROUND

Federated learning (FL) is a distributed Machine Learning (ML) paradigm that allows multiple clients to collaboratively train a global model without sharing their raw data. In traditional ML, a centralized server collects and stores all data for training, which can be a privacy and security hole when dealing with sensitive data and inserts a high cost of transmission in the network. FL solves this problem by allowing multiple clients to perform local training on their own data and then share the trained model weights or gradients with a central server, which in turn combines the models from multiple clients into a global model. This improves client's privacy and security and reduces the network bandwidth cost by keeping raw data decentralized.

In the traditional FL approach, the training process starts with the server identifying the clients of the federation and sending to them an initial model weight. Then each client trains the model locally on its own data. The updated weights or gradients are sent to the central server, which aggregates to update the global model with their respective contributions. Next, the server sends back the updated global model to participating clients to start a new local training cycle. This process is repeated until the global model converges with high accuracy, until several training cycles are completed, or a stopping condition is reached.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a Federated Learning (FL) setting;

FIG. 2 discloses aspects of a FL server and client node monitor module;

FIGS. 3A-3D disclose aspects of a client node score list;

FIG. 4 discloses aspects of a process flow according to an embodiment; and

FIG. 5 discloses an example computing entity configured to perform any of the disclosed methods, processes, and operations.

### DETAILED DESCRIPTION OF SOME EXAMPLE EMBODIMENTS

Embodiments disclosed herein relate to federated learning processes. More particularly, at least some embodiments of the invention relate to systems, hardware, software, computer-readable media, and methods for weighting or pruning client node contributions in a federated learning system.

In general, example embodiments of the invention are directed towards selecting client nodes for inclusion in a Federated Learning cycle based on a client node score and then weighting or pruning their contributions based on the client node score. One example method includes calculating a correlation metric based on a historical consistency of each local ML model. An encrypted model is returned to a central server from each client node of a federated learning system. A model is used to monitor network traffic between the central server and the client nodes to detect anomalous network traffic behavior based on historical network traffic behavior. Then, a defined function calculates a performance score based on a historical performance of the local ML model. A client node score is calculated based on the correlation metric, any detected anomalous behavior in the network traffic, and the performance score. One or more client nodes are selected based on the client node score. A global model is updated by aggregating each local models returned to the central server from the selected client nodes and weighting the contribution of each local model according to client node score of the client node that returned each local model.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. FEDERATED LEARNING

Federated Learning (FL) consists of a distributed framework for Machine-Learning (ML) in which a global model is trained jointly by several nodes without ever sharing their local data. FL is an essential area for companies interested in providing infrastructure for private distributed machine-learning (e.g., massive deployment of ML models to the edge where data must be kept local due to compliance, cost, or strategic reasons).

Standard FL settings are composed of client nodes, which are configured to perform local training using their own private datasets and maintain local models, and a server, which is configured to unify the local models in a unique global model based on client nodes' updates, in a step called aggregation. This process is performed iteratively for several rounds. Note that this approach ensures that the private data is not directly handled by the server as the client nodes only share model weights and not the underlying datasets.

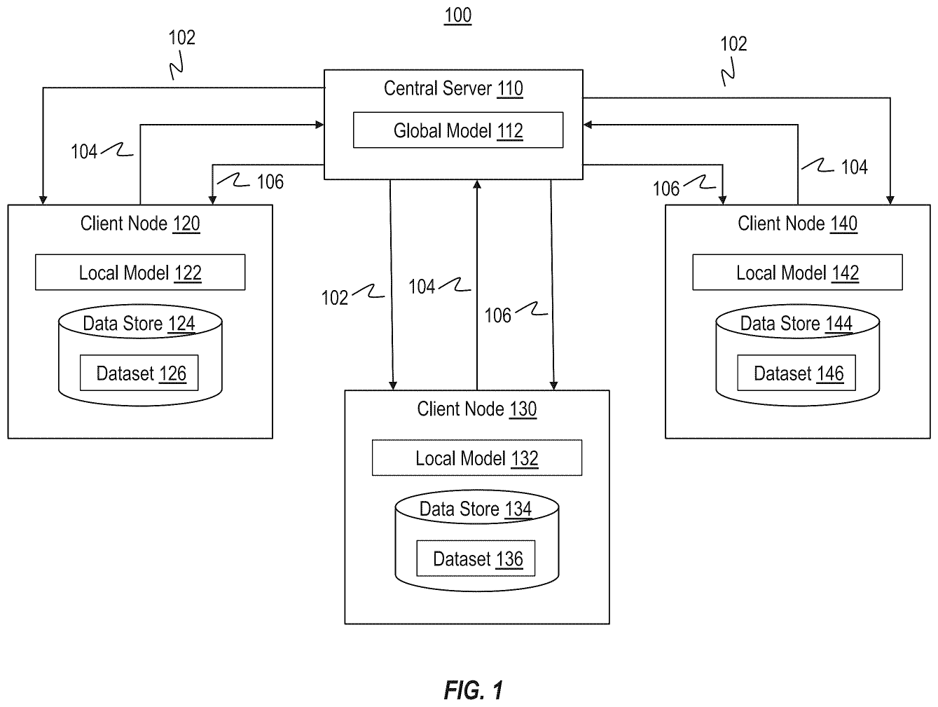

FIG. 1 illustrates a FL setting 100. In the FL setting 100, a central server 110 provides an initial global model 112 that has been initialized with random weights based on the type of the global model (e.g., health model, financial services model, movie review model, etc.) to a client node 120, a client node 130, and a client node 140 as shown at 102. The client node 120 includes a local model 122 and a local data store 124 that stores a local dataset 126. The client node 130 includes a local model 132 and a local data store 134 that stores a local dataset 136. The client node 140 includes a local model 142 and a local store 144 that stores a local dataset 146. The global model 112 and the local models 122, 132, and 142 may be any reasonable ML model such as, but not limited to, deep neural networks, convolutional neural networks, multilayer neural networks, recursive neural networks, logistic regressions, isolation forests, k-nearest neighbors, support vector machines (SVM), or any other reasonable machine-learning model. It will be understood that the local models are local versions of the global model that is provided to the client nodes by the central server during an initial cycle.

The client node 120 performs local training on the local model 122 using the local dataset 126. Likewise, the client node 130 performs local training on the local model 132 using the local dataset 136. In a similar manner, the client node 140 performs local training on the local model 142 using the local dataset 146.

As a result of the local training, the local models 122, 132, and 142 are updated to fit the local datasets 126, 136, and 146 respectively to the global model 112. As shown at 104, the updated local models 122, 132, and 142 are sent by the client nodes to the central server 110, which aggregates the updates of all client nodes to obtain an updated global model 112. This new updated global model 112 is then sent back to the client nodes 120, 130, and 140 as shown at 106 and become the local models 122, 132, and 142. This cycle is repeated iteratively for a user determined amount of update rounds. It will be noted that after each cycle, each of the client nodes have a local model (i.e., local models 122, 132, and 142) that not only fits each client nodes local datasets (i.e., local datasets 126, 136, and 146), but that also fits the local datasets of the other client nodes, resulting in a local model with a good generalization. It will be appreciated that in some embodiments when sending the updated local models to the central server 110, each client node is actually sending model gradient data that is the result of training the local models using the local datasets. It is the model-weights that is then used to update the global model 112. In this way, the local datasets are not sent to the central server 110 to thereby preserve privacy of the local datasets.

FL implements strong privacy guarantees. However, it suffers from specific security issues not necessarily present in other ML scenarios. For instance, it is known that the distributed nature, architectural design, and data constraints of federated learning open up new failure modes and attack surfaces. Several of these attacks aim to compromise the privacy of client nodes.

For example, a malicious client node can try to damage the global model by sending corrupted models during the global update, with the aim of making the global model converge to an unwanted solution or impairing its performance. In addition, the malicious client node may present suspicious activities such as sending sudden updates with the aim of exploiting vulnerabilities in the training process or in the communication protocol.

In some embodiments during each FL training cycle, only some of the available client nodes are selected to participate in the training. This client node selection is a useful strategy to ensure some important aspects such as privacy, security, and quality of users' data, avoiding malicious client nodes or faulty models that could damage the global model and expose data privacy. Thus, it is important to add to the FL structure a robust mechanism that considers measures such as data authenticity, behavior analysis and anomaly detection during the selection of client nodes for use by the federation and during the global aggregation stage.

### B. ASPECTS OF SOME SAMPLE EMBODIMENTS

The embodiments disclosed herein provide for such robust mechanism that helps ensure efficient client selection and aggregation to increase security in the FL learning environment. In particular, the embodiments disclosed herein:
1. Introduce a parameterizable function per application or global model, as well as a new scoring system that incorporates three main factors: client node authenticity, anomaly detection, and performance evaluation, to help an FL server to choose the best client nodes in each FL training cycle,
2. Provide a mechanism for pruning suspicious client nodes based on real-time monitoring, and
3. Provide a weighting system for each client node's contributions to the global model aggregation.

Thus, the embodiments disclosed herein consider the correlation of a model change aggregate value to assess client node authenticity, which allows for the identification of robust changes in a model. Additionally, the anomalous behavior of a client node is analyzed to incorporate security aspects into the score and prune client node participation in the aggregation phase if, after being selected, the client node acts suspiciously. This incorporates two-phase security, in the selection and aggregation phase for FL algorithms. The performance of the model is also given due consideration, as it significantly impacts the usefulness of the approach to the global model. These contributions, when combined, result in a more reliable and effective solution that represents a significant novelty in the field. Furthermore, the embodiments disclosed are highly flexible and can be adapted to different scenarios, making it a versatile solution for a range of applications.

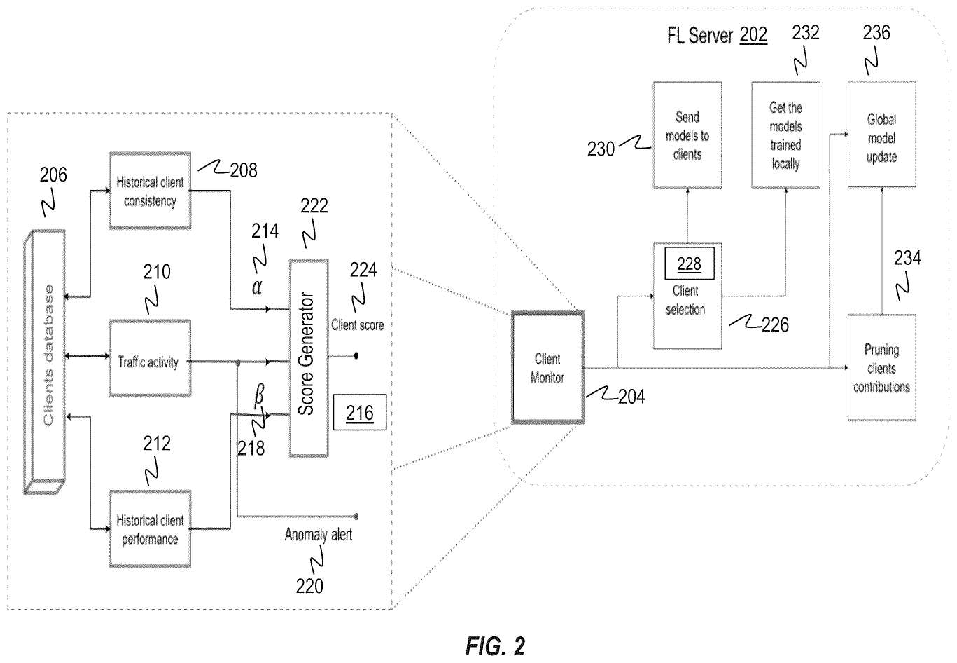

FIG. 2 illustrates an embodiment of an FL central server 202, which in some embodiments may correspond to the FL central server 110 previously described, and which is configured to implement the embodiments disclosed herein. As illustrated, the FL central server 202 includes a client node monitor module 204. In operation, the client node monitor module 204 is configured to monitor each client node in the federation such as the client nodes 120, 130, and 140 previously described and then to return a client node score 224 for each of the client nodes. The client node score 224 is then used in the selection process for client nodes to be used in a FL training cycle as will be explained in more detail to follow.

The client node monitor module 204 includes or otherwise has access to a clients database 206. The clients' database 206 is used to store historical encrypted data about each client node that is then used to help generate the client node score 224 for each client node. In operation, the client node monitor module 204 writes and sends the historical encrypted data about each client node to the clients' database 206 during each FL training cycle so that this data is available for use during a subsequent FL training cycle to generate the client node score 224 for each client node.

As shown in FIG. 2, the client node monitor module 204 includes a historical client node consistency function 208 that, in operation, determines a correlation metric to determine the historical consistency of a local model (e.g., local models 122, 132, and 142) that is returned to the FL central server 202 by a given client node. To calculate the correlation metric, the historical client consistency function 208 can apply Pearson, Spearman, or other correlations depending on the nature of the returned local model. A high correlation indicates the consistency and authenticity of the returned local model.

In other words, correlation metrics measure the monotonic relationship between two continuous variables. In the disclosed embodiments, the returned local models sent to the FL central server 202 are the continuous variables. An encrypted returned local model at a time t−1 is correlated with an encrypted returned local model at a time t, from cryptography operations for each client node. The correlation metric applied to the encrypted returned local models would indicate the degree of similarity between the returned local models without revealing the underlying data content, indicating consistency between the returned local models. A high correlation between the returned local models (e.g., the returned local models at time t and the previous returned local models stored at the clients' database 206 at time t−1 by the client node monitor module 204) indicates similarity and consistency between the local models sent by the client nodes, thus guaranteeing authenticity of the data. The correlation metric is used to help determine the client node score 224.

The client node monitor module 204 also includes a traffic activity model 210. The traffic activity model 210 may be implemented as any reasonable ML model such as those discussed previously, including K-means and Random Forrest. The traffic activity model 210 may also be implemented as a statical analysis function or the like that uses statistical analysis to determine anomalies. The traffic activity model 210 considers the client behavior in real time to detect anomalies and suspicious activity in network traffic. In operation, the traffic activity model 210 learns the frequency and the average volume of network traffic that each client node sends to the FL central server 202, and with that the traffic activity model 210 manages to detect network traffic with unusual patterns of volume or frequency. This information about the network traffic is then used help generate the client node score 224.

In some embodiments, the traffic activity model 210 is configured to generate an anomaly alert 220 when an anomaly is detected in the data that is being sent to the FL central server 202. An anomaly may be detected when the changes in frequency or volume of the network traffic exceeds a predefined threshold or exceeds an historical average for a given client node. In one embodiment, the anomaly alert 220 causes that the client node score 224 of a given client node to be automatically set to 0, which as will be explained in more detail to follow will cause the given client node to be pruned or removed from the list of client nodes used in the FL training cycle. In addition, the anomaly alert 220 may be provided to a user in the form of an alarm or the like that notifies the user that an anomaly has been detected.

The client node monitor module 204 further includes a historical client performance function 212 that in operation provides insight into the reliability of each returned local model's contributions to the FL learning cycle. This helps to ensure that only client nodes who return high-performance local modes are selected for use in the FL learning cycle.

The historical client performance function 212 stores performance scores for each client node over multiple FL learning cycles, which can be a F1-score, for example. After a few iterations, the mean and standard deviations of the local model performance are known for each client node that participated in at least one FL learning cycle. Client nodes participating for the first time are considered with an average equal to the current value and zero deviation, to ensure that if their performance is high, they can participate in the current learning cycle. The output of the historical client performance function 212 is a numeric score normalized between 0 and 1. To protect the performance information of each local model and to avoid leakage information in the network, the use of cryptography methods, such as homomorphic encryption or secure aggregation during the transmission of these values may be used.

As illustrated in FIG. 2, input weighting parameters α 214 and β 218 may be included in the client node score 224 determination. The input weighting parameters α 214 and β 218 are defined by the underlying application or global model (e.g., global model 112) being trained by the FL learning process or they are learned. In FIG. 2, weighting parameter α 214 weights the output of the historical client node consistency function 208 and the weighting parameter β 218 weights the output of the historical client performance function 212.

For example, for a financial fraud detection model, the output of the historical client node consistency function 208 may be more important than the output of the historical client performance function 212. In such case, weighting parameter α 214 is set higher than weighting parameter β 218 so that the output of the historical client node consistency function 208 has more effect on the determination of the client node scores 224.

In contrast, for a health diagnostics model, the output of the historical client performance function 212 may be more important than historical client node consistency function 208. In such case, weighting parameter β 218 is set higher than weighting parameter α 214 so that the output of the historical client performance function 212 has more effect on the determination of the client node scores 224.

The client node monitor module 204 further includes a client node score generator 222. In operation, the client node score generator 222 receives as input the output of the historical client node consistency function 208, the traffic activity model 210, and the historical client performance function 212. Based on this input and in consideration of the weighting parameters α 214 and β 218, the client node score generator 222 generates the client score 224 for each client node of the federation. In one embodiment, the client node score generator 222 generates a client node score list 216 that lists an ID for each client node and its client node score.

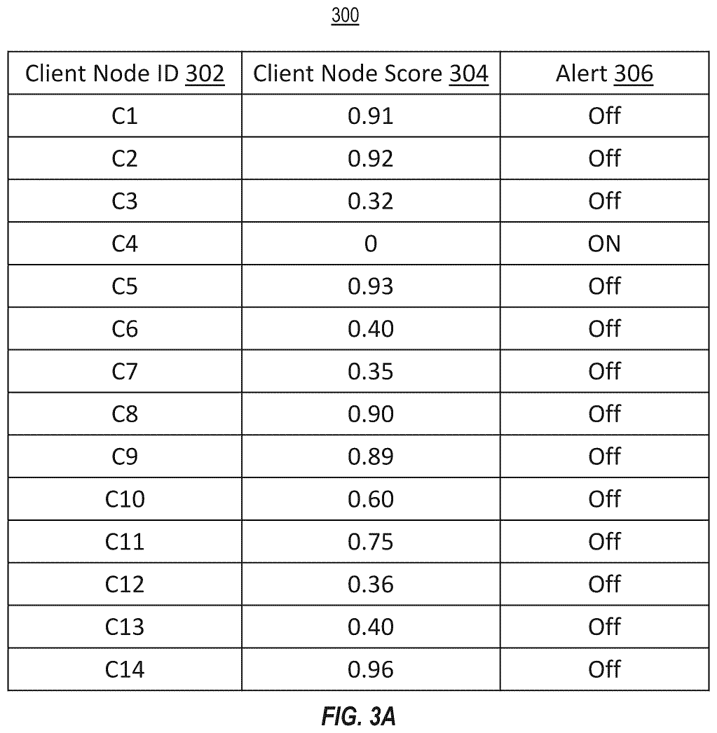

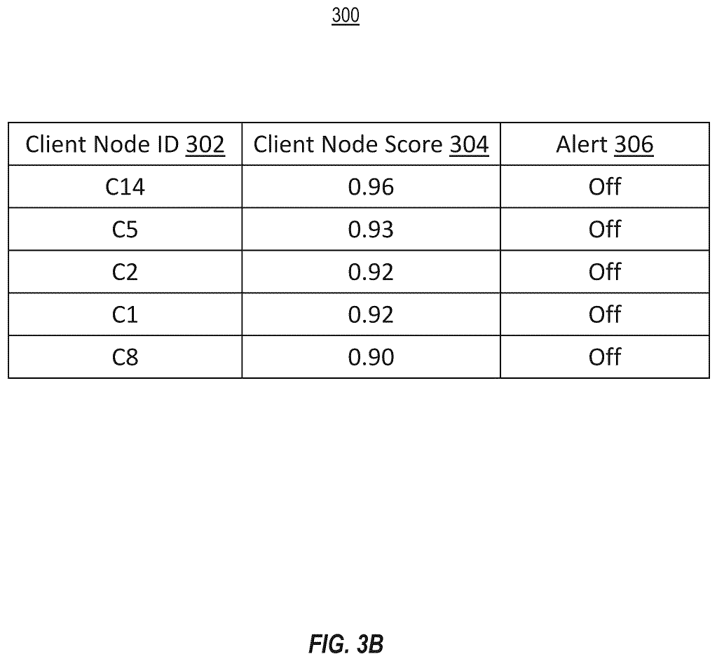

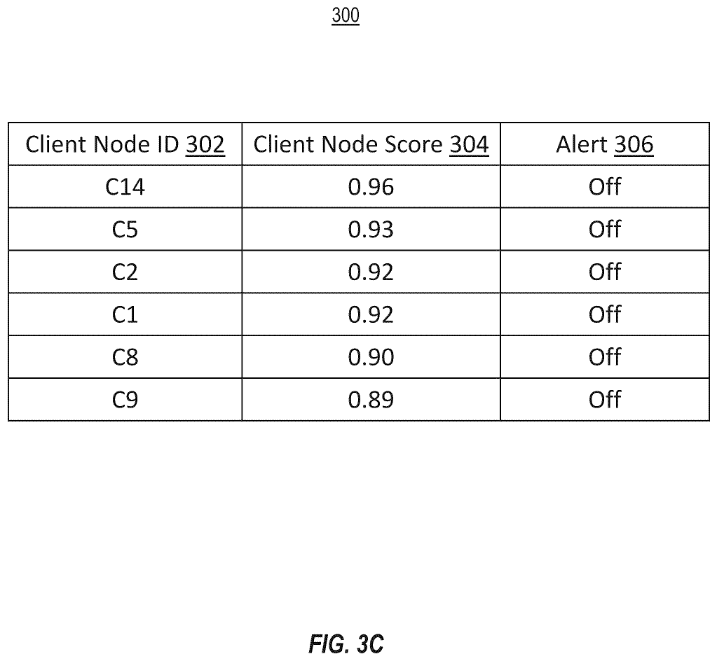

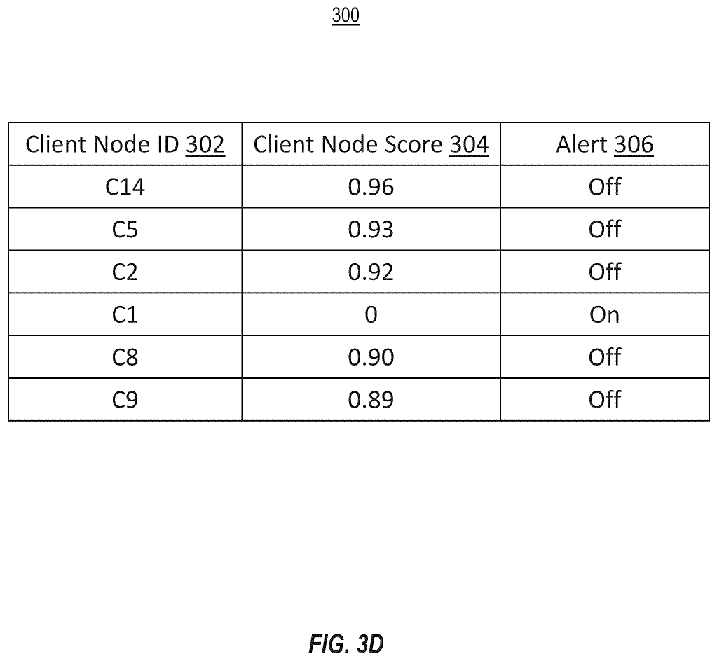

FIG. 3A illustrates an embodiment of a client node score list 300, that corresponds to the client node score list 216. As illustrated, the client node list 300 includes client node IDs 302 and client node scores 304 for each client node in the federation. In the embodiment of FIG. 3A, the federation includes 14 client nodes having client node IDs 302 of C1-C14. Each of the 14 client nodes also have a client node score 304. For example, client node C1 has a client node score of 0.91, client node C2 has a client node score of 0.92, client node C3 has a client node score of 0.32, client node C4 has a client node score of 0, client node C5 has a client node score of 0.93, client node C6 has a client node score of 0.40, client node C7 has a client node score of 0.35, client node C8 has a client node score of 0.90, client node C9 has a client node score of 0.89, client node C10 has a client node score of 0.60, client node C11 has a client node score of 0.75, client node C12 has a client node score of 0.36, client node C13 has a client node score of 0.40, and client node C14 has a client node score of 0.96.

In some embodiments, the client node score list 300 includes an alert or alarm 306. The alert 306 indicates whether an anomaly alert 220 is generated by the traffic activity model 210 and is indicated by “On” when the anomaly alert 220 is generated. When an anomaly alert is not generated, the alert 306 shows “Off”. In the illustrated embodiment, alert 306 is “On” for client node C4, which has a client node score 304 of 0. As previously discussed, in some embodiments the anomaly alert 220 causes that the client node score of a given client node to be automatically set to 0, which is the case here.

The following shows an example implementation of the client node monitor module 204:

Custom function client_monitor (α, β, client, clients_database)

| | |
|---|---|
| _{1.} | get parameters (α, β) |
| _{2.} | id = client.id |
| _{3.} | cl = client |
| _{4.} | clients_database |
| _{5.} | consistency( clients_database), traffic( clients_database), |
| | performance(clients_database) |
| _{6.} | do forever ( ): |
| _{7.} | if traffic(cl): # if an anomaly is detected |
| _{8.} | anomalie = 1 |
| _{9.} | score = 0 |
| _{10.} | else: |
| _{11.} | anomalie = 0 |
| _{12.} | score = α * consistency(clients[cl]) + traffic(cl) + |
| | β * performance(cl)/(α + β + γ) |
| _{13.} | save in clients_database |
| _{14.} | return id, score, anomalie |

The client node monitor module 204 also includes a client node selection module 226. In operation, the client node selection module 226 accesses the client node score list 216 and uses the client nodes scores 224 to determine the best client nodes to use in the next FL learning cycle. Those client nodes having the highest scores will typically be the best to select since they should show the most model consistency, no traffic anomalies, and the best model performance. Thus, the selected client nodes will provide the best results to be used in the global model update process.

The client node selection module 226 sorts the client node score list 216 by client node score 224 and chooses the first n client nodes having the highest client node scores, where the variable n corresponds to the number of client nodes that the underlying global model defines as the amount of client nodes needed for properly training the global model. Thus, the client node selection module 226 chooses n among m available client nodes.

It is possible, however, that the number m of available client nodes is very small or their client node scores are not good. Accordingly, the client node selection module 226 determines an adaptive threshold 228 that is used to filter out those client nodes whose client nodes scores 224 are below the adaptive threshold 228, thus indicating that their results may be harmful to the use when updating the global model.

As mentioned, the adaptive threshold 228 is adaptive based on the needs of the underlying global model. Thus, an adaptive threshold 228 that is too high may not be adequate, because it can greatly limit the number of participating client nodes, but also an adaptive threshold 228 that is too low may allow choosing client nodes with low performance or high inconsistency in their data, which in both cases will affect the precision of the global model. Accordingly, in some embodiments the adaptive threshold 228 is determined based on the mean and standard deviation of the first n clients having the highest client node scores in the sorted client node score list 216.

As mentioned previously, the client node selection module 226 chooses n among m available client nodes. However, there are instances where n>m. In such instances the client node selection module 226 chooses the first x client nodes from the client nodes scores list 216 whose client node score 224 is higher than or exceeds the adaptive threshold 228.

The adaptive threshold 228 can also be adjusted according to the global model being trained, given that some models may be more rigorous than others. For example, suppose two models are being trained in the federated learning setting 100, a health diagnosis model and a movie recommendation system model. For the health model, it may be desirable to set the adaptive threshold 228 to a higher value than the mean and standard deviation of the first n clients so as to only select more reliable client nodes. Conversely, for the movie recommendation model, it may be more interesting to train with more client nodes, even if the client nodes have lower client nodes scores 224, and so it may be desirable to set the adaptive threshold 228 to a lower value than the mean and standard deviation of the first n clients so as to select more client nodes.

Accordingly, the client node selection module 226 uses a threshold weighting parameter γ that is configured to weight up or down the adaptive threshold 228 according to the specific global model, to ensure a compromise between precision and generalization according to the model requirements. Thus, if threshold weighting parameter γ is used to weight down the adaptive threshold 228, it means that the adaptive threshold 228 will be lowered. This will allow more client nodes to be selected for training, which can result in greater data diversity and greater client nodes representativeness and model generalization. This can be useful for heterogeneous scenarios and when the global model does not require strong reliability constraints. On the other hand, if threshold weighting parameter γ is used to weight up the adaptive threshold 228, it means that the adaptive threshold 228 will be higher. This which means that only the best performing client nodes will be selected for training. This can be useful in scenarios where precision is critical and where errors can have a significant impact, as is the case in a healthcare model or in a critical security system.

The following shows an example implementation of the client node selection module 226:

Select n clients (n, α, β, γ, clients: list, clients_database,)

| _{1.} | n−→ | # number of clients for FL |
|---|---|---|
| | | training |
| _{2.} | m = len(clients) | # all clients available |
| _{3.} | slist = [ ] | # list to save scores for all |
| | | available clients |
| _{4.} | for each client in clients: | |
| _{5.} | slist.append(client_monitor(α, β, client, clients_database | |
| 3. | slist.sorted(#by score) | # list sorted by score |
| 4. | mean= get_mean(slist[ ]) | # computes the mean |
| 5. | desviation = | # computes the standard |
| | get_std_desviation(slist[ ]) | deviation |
| 6. | th = mean − desviation | # the threshold |

| | |
|---|---|
| 7. | x = slist[score ≥ γ * th] |
| 8. | if len(x) ≥ n: |
| 9. | selected_clients = x[:n] |
| 10. | else: |
| 11. | selected_clients = x |
| 12. | return selected_clients |

After the client node selection module 226 selects the client nodes to be used in the FL training cycle, the FL server 202 sends the global model to the selected client nodes as shown at 230 (102 in FIG. 1). The global models are locally trained by the selected client nodes and returned to the FL server as shown at 232 (104 in FIG. 1). This process will be further explained in more detail to follow.

The client node monitor module 204 includes a client node pruning module 234 that in operation provides real-time monitoring of any detected anomalies in the network traffic monitored by the traffic activity model 210. The client node pruning module 234, when an anomaly is detected, prunes or removes the client node having the anomaly from the client score list 216 as will be explained in more detail to follow.

In other words, although client nodes are chosen carefully by the client node selection module 226, this does not remove the possibility that they may later participate in suspicious activity. This is why the client node pruning module 234 provides real-time monitoring of any detected anomalies in 220 so that a client node having the anomaly is pruned prior to the aggregation stage of the global model. The pruning action corresponds to eliminating from the client node score list 216 the client node that engages in suspicious activity by setting the node client score to 0. Anomaly detection is a temporal event that can occur at any stage of training in a federated environment, in client selection stage, during local training, or during global aggregation. Once the anomaly is detected, the client node is eliminated from the current FL training cycle, their contributions are no longer accepted, and the connection is interrupted.

The client node monitor module 204 includes a global model update weighting module 236 that is used during the global model update or aggregation process. In operation, the global model update weighting module 236 weights the contribution of each locally trained model for each selected client node based on the client node scores 224. Thus, the selected client node with the highest client node score 224 is weighted the highest and so one in descending order to thereby ensure that the client node with the highest reliability and performance has the most impact on the updated global model as will be explained in more detail to follow.

In other words, after the local model training phase on the client nodes selected in the manner previously described, the global model aggregation phase takes place. In traditional FL, this aggregation is carried out by a centralized server responsible for collecting the models of each client previously selected to combine them in a global model. In the embodiments disclosed herein the global model update weighting module 236 uses a weighted average, assigning the client node scores 224 as weights for each client node contribution, making S=w₁*s₁+w₂*s₂+ . . . +wₙ*sₙ, where s₁ is the highest client node score 224 and w₁ is a first weight, s₂ is the next highest client node score 224 and w₂ is a second weight, and so on.

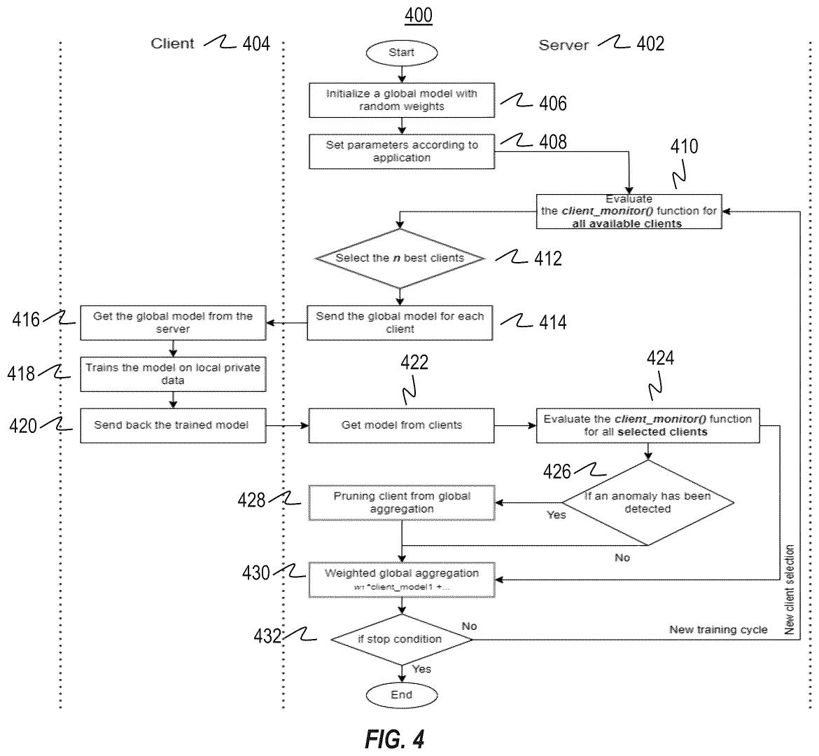

A use case showing the operation of the client node monitor module 204 and its various modules and operations as well as the other elements of the FL setting 100 will now be explained in relation to a process flow 400 shown in FIG. 4. The description of the process flow 400 will refer to one or more of the other figures discussed herein as needed. As shown in FIG. 4, some of the steps of the process flow are performed in an FL server 402 that corresponds to the FL server 110 and 202 previously discussed and in client nodes 404 that correspond to one or more of the client nodes 120, 130, and 140.

At step 406, the global model is initialized by the FL server 402 with random weights that are based on the type underlying global model as previously described in relation to FIG. 1. At step 408, input weighting parameters α 214 and β 218 are set according to the underlying application or global model. As previously described, the input weighting parameter α 214 sets a weight to the output of the historical client node consistency function 208 and the input weighting parameter β 218 sets a weight to the output of the historical client performance function 212. Thus, applications where consistency is more important will set the input weighting parameter α 214 to be higher and applications where performance is more important will set the input weighting parameter β 218 to be higher.

At step 410, the client node monitor module 204 evaluates each of the client nodes to determine a client node score 224 for each client node 404. As previously described, the client score generator 222 takes as input the weighted output of the historical client node consistency function 208, the output of the traffic activity model 210, and the weighted output of the historical client performance function 212. The client score generator 222 then generates the client node scores 224 and generates the client node score list 216 that lists an ID for each client node and its client node score. Suppose in the use case, the federation includes 14 client nodes. In such case, the client node score list 300 having client node IDs 302 of C1-C14, client node scores 304, and an alert or alarm 306 as shown in FIG. 3A would be generated.

At step 412, the client node selection module 226 selects the best n client nodes for use in the FL learning cycle. As previously described, the variable n corresponds to the number of client nodes that the underlying global model defines as the amount of client nodes needed for properly training the global model. Suppose in the use case that variable n is six.

The client node selection module 226 then determines the adaptive threshold 228 based on the mean and standard deviation of the first n clients having the highest client node scores in the client node score list 300. Suppose in the use case, the adaptive threshold 228 is 0.91 and the standard deviation is 0.1. This will lead the client node selection module 226 to sort the client node score list 300 according to the highest client node scores 304 that exceed the adaptive threshold 228 and to filter out those client node scores 304 that are below the adaptive threshold 228. This results in a client node score list 300 shown in FIG. 3B. As illustrated, the client node IDs 302 and client node scores 304 are listed from highest value and have the following order: client node C14 has a client node score of 0.96, client node C5 has a client node score of 0.93, client node C2 has a client node score of 0.92, client node C1 has a client node score of 0.92, and client node C8 has a client node score of 0.90. Thus, client nodes C14, C5, C2, C1, and C8 are selected to use in the FL learning cycle. At step 414 the global model is sent to client nodes C14, C5, C2, C1, and C8 for local training.

As mentioned previously, the variable n is six but only five client nodes exceeded the adaptive threshold 228. If the underlying global model is of a type where selecting less than n client nodes would lead to acceptable results, then use of only the client nodes C14, C5, C2, C1, and C8 would be sufficient as previously described. However, if the underlying global model is of a type where the results would be less useful using less than n client nodes, then the threshold weighting parameter γ can be utilized. As previously discussed, the threshold weighting parameter γ allows the adaptive threshold 228 to be weighted up or down as needed.

Suppose in the use case that the underlying global model is of a type where the results would be less useful using less than n client nodes and that the threshold weighting parameter γ is 0.97. This would weight down the adaptive threshold 228 to allow six client nodes to be chosen. This results in a client node score list 300 shown in FIG. 3C. As illustrated, the client node IDs 302 and client node scores 304 are listed from highest value and have the following order: client node C14 has a client node score of 0.96, client node C5 has a client node score of 0.93, client node C2 has a client node score of 0.92, client node C1 has a client node score of 0.92, client node C8 has a client node score of 0.90, and client node C9 has a client node score of 0.89. Thus, in this embodiment client nodes C14, C5, C2, C1, C8, and C9 are selected to use in the FL learning cycle. At step 414 the global model is sent to client nodes C14, C5, C2, C1, C8, and C9 for local training.

At step 416, the selected client nodes 404 (e.g., client nodes C14, C5, C2, C1, and C8 or client nodes C14, C5, C2, C1, C8, and C9) receive the global model from the FL server 402. At step 418, the selected client nodes 404 perform local training on the local model (e.g., local models 122, 132, 142) using their local datasets (e.g., local datasets 126, 136, and 146) in the manner previously described in relation to FIG. 1. At step 420, the selected client nodes 404 send back the locally trained models to the FL server 402 in the manner previously described in relation to FIG. 1.

At step 422, the locally trained global models are received from the selected client nodes 404 by the FL server 402 and at step 424 are evaluated by the client node monitor module 204. As previously discussed, the client nodes 404 are monitored in real time by the traffic activity model 210 to detect any network traffic anomalies. If the traffic activity model 210 detects an anomaly in the network traffic of a client node 404 (Yes in decision step 426), the client node pruning module 234 will prune or remove that client node from the FL learning cycle at step 428 so that its locally trained model is not used in the aggregation process of updating the global model at step 430. If the traffic activity model 210 does not detect an anomaly in the network traffic of a client node 404 (No in decision step 426), then all the locally trained models will be used in the aggregation process of updating the global model at step 430.

Suppose in the use case that the client nodes C14, C5, C2, C1, C8, and C9 returned the locally trained global models at steps 420 and 422. In addition, suppose that the traffic activity model 210 detected an anomaly in the network traffic of client node C1. In such case, the client score generator 222 would set the client score 304 of the client node C1 to 0. This is shown in the client node score list 300 shown in FIG. 3D. Thus, the locally trained model of the client node C1 is not used in the aggregation process of updating the global model.

At step 430, the global model update weighting module 236 weights the contribution of each locally trained model for each selected client node based on the client node scores 224. In the use case using the client node score list 300 of FIG. 3D, the client node C14 has the highest client node. Accordingly, when aggregating the locally trained models to update the global model, the locally trained model of client node C14 would be weighted highest, the locally trained model of client node C5 would be weighted next highest, and so forth until locally trained model of client node C9, which would be weighted the lowest.

If a stop condition such as model convergence or a predetermined number of FL training cycle is reached (Yes in decision step 432), the process flow 400 ends. However, if a stop condition is not reached (No in decision step 432), the process flow 400 returns to step 410 and the process is repeated until a stop condition is met. The process flow 400 can take advantage of the client node score as a way of rewarding participating client nodes, and as an explanation of the value gained by their contribution, as well as an explanation to client nodes who were excluded from the FL training cycle. This helps encourage client nodes to improve their local training.

### C. FURTHER EXAMPLE EMBODIMENTS

Following are some further example embodiments of the invention. These are presented only by way of example and are not intended to limit the scope of the invention in any way.

Embodiment 1. A method performed at a central server of a federated learning system, the method comprising: calculating, using a first function, a correlation metric based on a historical consistency of a local ML model that is returned encrypted to the central server from a plurality of client nodes of the federated learning system; monitoring, using a ML model, network traffic between the central server and the plurality of client nodes to detect anomalous behavior in the network traffic based on historical network traffic behavior between the central server and the plurality of client nodes; calculating, using other function, a performance score based on a historical performance of the local ML model that is returned encrypted to the central server from the plurality of client nodes; calculating a client node score for each of the plurality of client nodes based on the correlation metric, any detected anomalous behavior in the network traffic, and the performance score; selecting one or more of the plurality of client nodes for inclusion in a federated learning cycle based on the client node score of each of the plurality of client nodes; and updating a global ML model by aggregating local models returned to the central server from the selected one or more client nodes, weighting their contributions according to their score.

Embodiment 2. The method as recited in embodiment 1, further comprising: receiving first and second input weighting parameters based on the global ML model; applying the first input weighting parameter to the correlation metric; and applying the second input weighting parameter to the performance score

Embodiment 3. The method as recited in any of embodiments 1-2, wherein selecting the one or more of the plurality of client nodes for inclusion in the federated learning cycle comprises: applying an adaptive threshold to each of the client node scores; and selecting the one or more of the plurality of client nodes having a client node score that exceeds the adaptive threshold.

Embodiment 4. The method as recited in any of embodiments 1-3, further comprising: applying a threshold weighting parameter to the adaptive threshold to thereby weight up or down the adaptive threshold.

Embodiment 5. The method as recited in any of embodiments 1-4, wherein the adaptive threshold is determined based on a mean and standard deviation of a number of client nodes specified by the global ML model as being needed for updating the global model.

Embodiment 6. The method as recited in any of embodiments 1-5, wherein when a number of available client nodes is less than a number of client nodes specified by the global ML model as being needed for updating the global ML model, the available client nodes having a client score that exceeds the adaptive threshold are selected.

Embodiment 7. The method as recited in any of embodiments 1-6, further comprising: removing a client node from the one or more selected client nodes when anomalous behavior in the network traffic between the client node and the central server is detected.

Embodiment 8. The method as recited in any of embodiments 1-7, wherein removing a client node from the one or more selected client nodes comprises setting the client node score to zero.

Embodiment 9. The method as recited in any of embodiments 1-8, wherein aggregating local models returned to the central server from the selected one or more client nodes comprises: weighting a contribution of each local ML model based on the client node score of the client node that returned the local ML model, wherein the contribution of the local ML model returned by the client node having a highest client node score is given the highest weight.

Embodiment 10. The method as recited in any of embodiments 1-9, wherein selecting the one or more of the plurality of client nodes for inclusion in the federated learning cycle comprises: generating a client node score list that lists a client ID for each client node, the client node score of each client node, and an anomaly alert for each client node.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### D. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that are executed on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to conduct executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

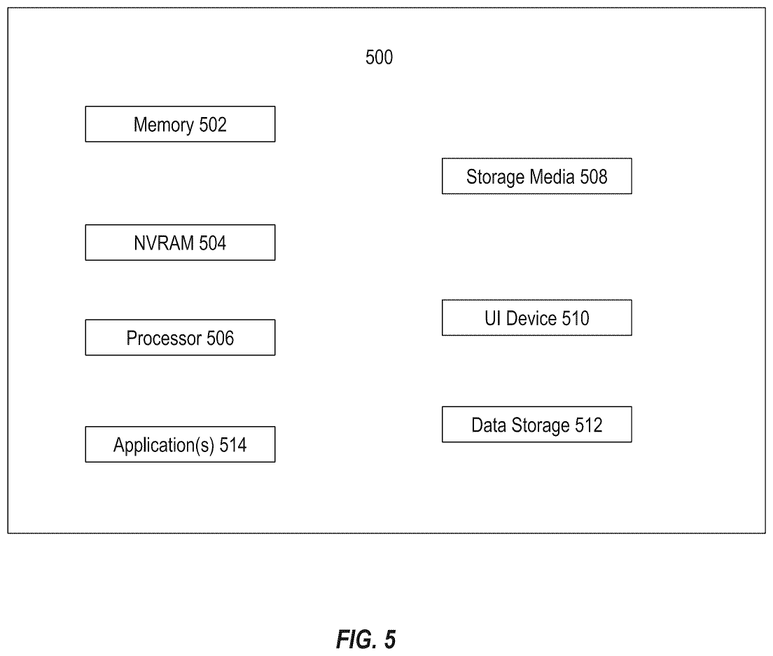

With reference briefly now to FIG. 5, any one or more of the entities disclosed, or implied, by FIGS. 1-4, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method performed at a central server of a federated learning system, the method comprising:
calculating, using a function, a correlation metric based on a historical consistency of a local ML model that is returned encrypted to the central server from a plurality of client nodes of the federated learning system;
monitoring, using a ML model, network traffic between the central server and the plurality of client nodes to detect anomalous behavior in the network traffic based on historical network traffic behavior between the central server and the plurality of client nodes;
calculating, using another function, performance score based on a historical performance of the local ML model that is returned encrypted to the central server from the plurality of client nodes;
calculating a client node score for each of the plurality of client nodes based on the correlation metric, any detected anomalous behavior in the network traffic, and the performance score;
selecting one or more of the plurality of client nodes for inclusion in a federated learning cycle based on the client node score of each of the plurality of client nodes; and
updating a global ML model by aggregating each local model returned to the central server from the selected one or more client nodes and weighting a contribution of each local model according to the client node score of the client node that returned each local model to the central server.

2. The method of claim 1, further comprising:
receiving first and second input weighting parameters based on the global ML model;
applying the first input weighting parameter to the correlation metric; and
applying the second input weighting parameter to the performance score.

3. The method of claim 1, wherein selecting the one or more of the plurality of client nodes for inclusion in the federated learning cycle comprises:
applying an adaptive threshold to each of the client node scores; and
selecting the one or more of the plurality of client nodes having a client node score that exceeds the adaptive threshold.

4. The method of claim 3, further comprising:
applying a threshold weighting parameter to the adaptive threshold to thereby weight up or down the adaptive threshold.

5. The method of claim 3, wherein the adaptive threshold is determined based on a mean and standard deviation of a number of client nodes specified by the global ML model as being needed for updating the global model.

6. The method of claim 3, wherein when a number of available client nodes is less than a number of client nodes specified by the global ML model as being needed for updating the global ML model, the available client nodes having a client score that exceeds the adaptive threshold are selected.

7. The method of claim 1, further comprising:
removing a client node from the one or more selected client nodes when anomalous behavior in the network traffic between the client node and the central server is detected.

8. The method of claim 7, wherein removing a client node from the one or more selected client nodes comprises setting the client node score to zero.

9. The method of claim 1, wherein the contribution of the local ML model returned by the client node having a highest client node score is given the highest weight.

10. The method of claim 1, wherein selecting the one or more of the plurality of client nodes for inclusion in the federated learning cycle comprises:
generating a client node score list that lists a client ID for each client node, the client node score of each client node, and an anomaly alert for each client node.

11. A non-transitory storage medium having stored therein instructions that are executable by one or more hardware processors to perform operations comprising:
calculating, using a first function, a correlation metric based on a historical consistency of a local ML model that is returned encrypted to a central server from a plurality of client nodes of a federated learning system;
monitoring, using a model, network traffic between the central server and the plurality of client nodes to detect anomalous behavior in the network traffic based on historical network traffic behavior between the central server and the plurality of client nodes;
calculating, using a second function, a performance score based on a historical performance of the local ML model that is returned encrypted to the central server from the plurality of client nodes;
calculating a client node score for each of the plurality of client nodes based on the correlation metric, any detected anomalous behavior in the network traffic, and the performance score;
selecting one or more of the plurality of client nodes for inclusion in a federated learning cycle based on the client node score of each of the plurality of client nodes; and
updating a global ML model by aggregating each local model returned to the central server from the selected one or more client nodes and weighting a contribution of each local model according to the client node score of the client node that returned each local model to the central server.

12. The non-transitory storage medium of claim 11, further comprising:
receiving first and second input weighting parameters based on the global ML model;
applying the first input weighting parameter to the correlation metric; and
applying the second input weighting parameter to the performance score.

13. The non-transitory storage medium of claim 11, wherein selecting the one or more of the plurality of client nodes for inclusion in the federated learning cycle comprises:
applying an adaptive threshold to each of the client node scores; and
selecting the one or more of the plurality of client nodes having a client node score that exceeds the adaptive threshold.

14. The non-transitory storage medium of claim 13, further comprising:
applying a threshold weighting parameter to the adaptive threshold to thereby weight up or down the adaptive threshold.

15. The non-transitory storage medium of claim 13, wherein the adaptive threshold is determined based on a mean and standard deviation of a number of client nodes specified by the global ML model as being needed for updating the global model.

16. The non-transitory storage medium of claim 13, wherein when a number of available client nodes is less than a number of client nodes specified by the global ML model as being needed for updating the global ML model, the available client nodes having a client score that exceeds the adaptive threshold are selected.

17. The non-transitory storage medium of claim 11, further comprising:
removing a client node from the one or more selected client nodes when anomalous behavior in the network traffic between the client node and the central server is detected.

18. The non-transitory storage medium of claim 17, wherein removing a client node from the one or more selected client nodes comprises setting the client node score to zero.

19. The non-transitory storage medium of claim 11, wherein the contribution of the local ML model returned by the client node having a highest client node score is given the highest weight.

20. The non-transitory storage medium of claim 11, wherein selecting the one or more of the plurality of client nodes for inclusion in the federated learning cycle comprises:
generating a client node score list that lists a client ID for each client node, the client node score of each client node, and an anomaly alert for each client node.
